(19) United States
(12) Patent Application Publication
(10) Pub. No.: US 2006/0129521 A1
(43) Pub. Date: Jun. 15, 2006

(54) System and method for restoring a file directory structure

(75) Inventor: Ting-Hsien Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/297,892

(22) Filed: Dec. 9, 2005

(30) Foreign Application Priority Data
Dec. 10, 2004 (TW) 93138279

(51) Int. Cl. G06F 17/30

(52) U.S. Cl. 707/1

(57) ABSTRACT

A system for restoring a file directory structure includes a storage (1) and a computer (2). The storage stores files and a file directory table. The computer is used for performing a file directory restoring program (20), which includes a directory table constructing module (201), a directory information reading module (202), and a directory structure restoring module (203). The directory table constructing module is used for constructing the file directory table according to the tree file directory. The directory information reading module is used for reading file directory information from the file directory table according to a file directory ID. The directory structure restoring module is used for restoring a file directory structure according to the file directory information. A related method is also disclosed.

### BACKGROUND OF THE INVENTION

1. Field of the Invention

The present invention relates to systems and methods for management files in a computer system, and more particularly to a system and method for restoring a file directory structure in the computer system.

2. General Background

Computer-based structured storage systems, such as computer file systems and database systems, have been remarkably successful at providing users with quick and facile access to enormous amounts of files. Structured storage systems have allowed the users to generate and maintain enormous stores of the files that users can modify and update over the course of years. A typical computer based structured storage system includes a central server that provides centralized control over the structured store of the files. The structured store of the files is the information that is being maintained by the system, such as information in the files and directories of a file system or within the records of a database system. The central server provides system services to a plurality of interconnected network client nodes, and each of the client nodes employs the central server to access and manipulate the structured store of the files.

It is common to use a storage to backup enormous amounts of files in order to ensure the security of these files. If each file name and file directory has not been recorded in a table, it is necessary to restore all data in the storage in the course of restoring the files. This requirement can be inefficient, time consuming, costly and wasting capacity of the storage. If all file name and the file directories have been recorded in a table, the users can selectively restore partial data according to the records in the course of restoring the files in the future. However, it is very enormous and redundancy to record all of the file name and the file directories in the storage. Therefore, a simplified structured storage system is required to reduce the huge capacity when storing the files name and its directory.

What is needed, therefore, is a system for restoring a file directory structure, which can selectively restore partial files and its directory according to users' requirements.

Similarly, what is also needed is a method for restoring a file directory structure, which can selectively restore partial files and its directory according to users' requirements.

### SUMMARY

A system for restoring a file directory structure in accordance with a preferred embodiment includes a storage and a computer. The storage stores files and a file directory table. The computer is used for performing a file directory restoring program, which includes a directory table constructing module, a directory information reading module, and a directory structure restoring module. The directory table constructing module is used for constructing the file directory table according to the tree file directory. The directory information reading module is used for reading file directory information from the file directory table according to a file directory ID. The directory structure restoring module is used for restoring a file directory structure according to the file directory information.

Another preferred embodiment provides a method for restoring a file directory structure by utilizing the above system. The method includes the steps: (a) constructing a file directory table; (b) reading a file directory in the file directory table; (c) confirming the start location of the file directory in the file directory table; (d) reading a parent directory of the file directory according to the start location; (e) determining whether the parent directory is a root directory; (f) reading the top parent directory of the file directory until the parent directory is the root directory, if the parent directory is not the root directory; or restoring a first full path of the file directory structure based on the parent directory, if the parent directory is a root directory; (g) determining whether the file directory exists a file with the same parent node in the same directory layer; and (h) restoring the full path of the file directory structure based on the parent node, if the file directory exist a file with the same parent node in the same directory layer.

In summary, the system and method can reconstruct a tree file directory structure, which can selectively restore partial files and its directory according to users' requirements.

Other advantages and novel features of the embodiments will be drawn from the following detailed description with reference to the attached drawings, in which:

### BRIEF DESCRIPTION OF THE DRAWINGS

FIG. 1 is a schematic diagram of hardware infrastructure of a system for restoring a file directory structure in accordance with a preferred embodiment of the present invention;

FIG. 2 is a flowchart of a preferred method for restoring a file directory structure by implementing the system;

FIG. 3 is a schematic graph of a tree file directory structure; and

FIG. 4 is a schematic diagram of a file directory table according to a preferred embodiment of the present invention.

### DETAILED DESCRIPTION OF THE EMBODIMENTS

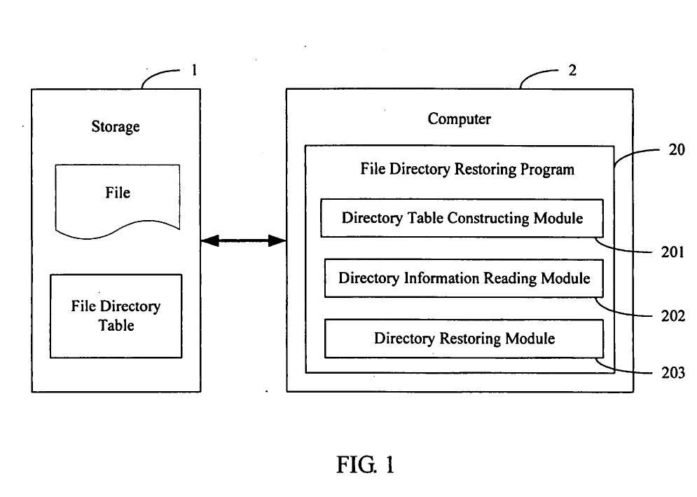

FIG. 1 is a schematic diagram of hardware infrastructure of a system for restoring a file directory structure (hereinafter, “the system”) in accordance with a preferred embodiment of the present invention. The system includes a storage 1 and a computer 2. The storage 1 may be a disk or other storage device, which stores a plurality of files and a file directory table. Properties of the file directory table include a start location of a file directory, parent nodes of a directory node, sub-nodes of the directory node, a file name, and length of the file name. The computer 2 performs a file directory restoring program 20, which is used for constructing a file directory table, reading the file directory structure information, and restoring a tree file directory structure. The file directory restoring program 20 includes a directory table constructing module 201, a directory information reading module 202, and a directory structure restoring module 203. The directory table constructing module 201 is used for constructing the file directory table according to the tree file directory structure. The directory information reading module 202 is used for reading the file directory information from the file directory table according to a shorten file directory ID assigned to a particular file directory. The directory information includes nodes information, parent nodes information of the node, sub-nodes information of the node, and the same directory layer nodes information. The directory structure restoring module 203 is used for restoring a file directory structure according to the file directory information.

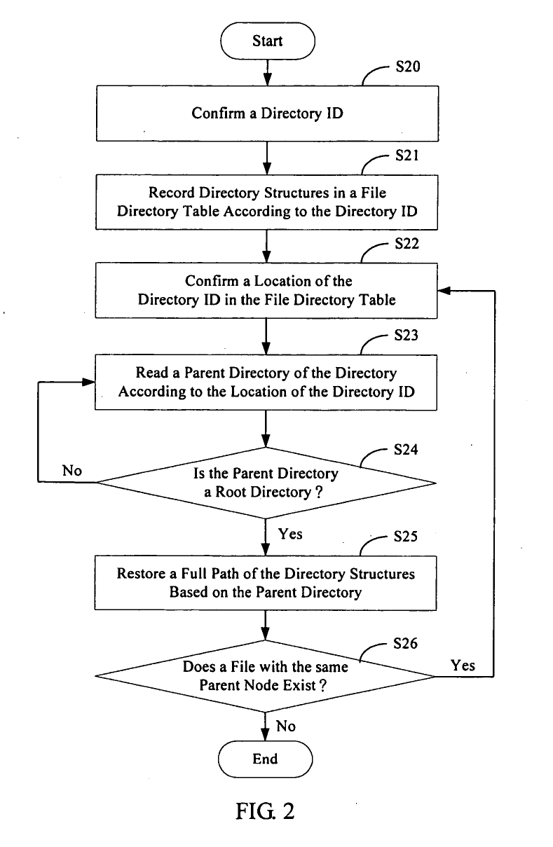

FIG. 2 is a flowchart of a preferred method for restoring a file directory structure by implementing the system. In step S20, the directory table constructing module 201 confirms a directory ID of a file directory to be restored. All directory IDs are predefined according to their sequence in the file directory table. In step S21, the directory table constructing module 201 records the file directory structure information according to the directory ID. In step S22, the directory information reading module 202 reads the directory ID from the file directory table, and confirms its location in the directory table. In step S23, the directory information reading module 202 reads a parent node information of the node. In step S24, the directory information reading module 202 determines whether the ID of the parent node is equal to “0,” that is whether the parent node is a root node. If the ID of the parent node is not equal to “0,” the procedure returns to the step S23 described above. Otherwise, if the ID of the parent node is equal to “0,” in step S25, the directory structure restoring module 203 restores a full path of the file directory structure in the root directory based on the parent directory. Then in step S26, the directory information reading module 202 determines whether the file directory exists another file with the same parent node in the same directory layer, by means of searching all file directory IDs in the file directory table. If the file directory the file directory exists another file with the same parent node in the same directory layer, the procedure returns to the step S22 described above. Otherwise, if the file directory does not exist another file with the same parent node in the same directory layer, the procedure is finished.

According to the above-described reconstruction procedures, an example of restoring a file directory structure by utilizing the system and the method is shown and described below.

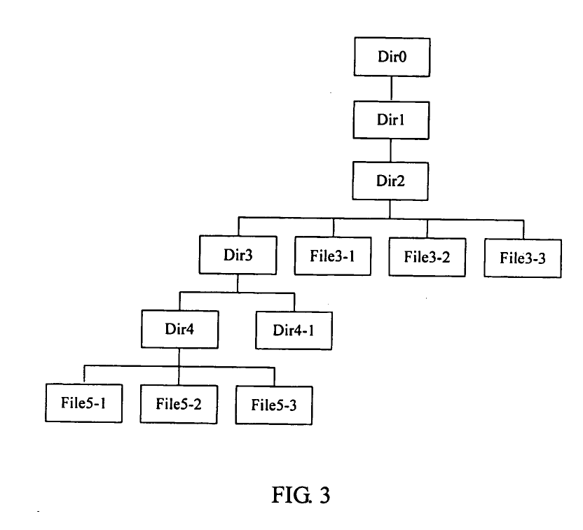

FIG. 3 is a schematic graph of a tree file directory structure of prior arts. The tree file directory structure information are recorded in a storage 1 and described with the following full paths:
Directory1: /Dir0/Dir1/Dir2/Dir3;
Directory2: /Dir0/Dir1/Dir2/File3-1;
Directory3: /Dir0/Dir1/Dir2/File3-2;
Directory4: /Dir0/Dir1/Dir2/File3-3;
Directory5: /Dir0/Dir1/Dir2/Dir3/Dir4;
Directory6: /Dir0/Dir1/Dir2/Dir3/Dir4-1;
Directory7: /Dir0/Dir1/Dir2/Dir3/Dir4/File5-1;
Directory8: /Dir0/Dir1/Dir2/Dir3/Dir4/File5-2; and
Directory9: /Dir0/Dir1/Dir2/Dir3/Dir4/File5-3.

According to the above-described file directory structures, it can be understood that the file directory information of “Dir0,” “Dir1” and “Dir2” need to be recorded in the storage 1 for nine times, the file directory information of “Dir3” needs to be recorded in the storage 1 for six times, and the file directory information of “Dir4” also needs to be recorded in the storage 1 for nine times. If there are enormous amounts of files or directories in the same directory layer, it is very enormous and redundancy to record the same file directory information in the storage 1.

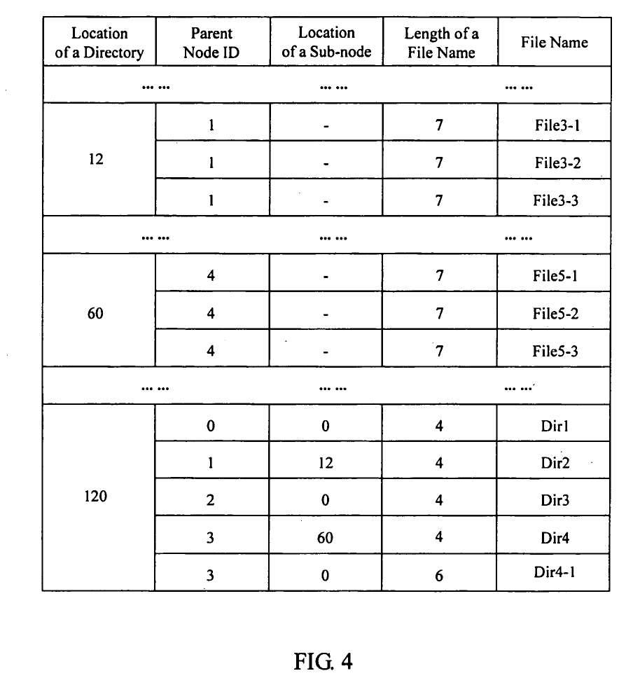

FIG. 4 is a schematic diagram of the file directory table according to a preferred embodiment of the present invention. Each file directory has an ID recorded in the file directory table, and the ID is predefined according to its sequence in the file directory table. For example, the root directory ID is “0,” the first directory ID is “1,” and the second directory ID is “2.” The file directory table records a parent node ID of the file directory having 4 bytes data, the length of the file name having 1 bytes data, and the start location of the directory having 8 bytes data. If the start location is “0,” which means there is no file in the directory. Therefore, the directory is recorded in the first location of the file directory table.

It is assumed that if the start location of a directory is “120,” the directory needs to be reconstructed a directory structure according to the above-described file directory table. The directory information reading module 202 reads each file directory information from the start location of the file in the file directory table. If the directory “Dir4-1” needs to restore its full path, the directory information reading module 202 reads the following directory information: the parent node ID of the directory “Dir4-1” is “3,” which means the parent directory of the directory “Dir4-1” is the directory “Dir3;” the parent node ID of the directory “Dir3” is “2,” which means the parent directory of the directory “Dir3” is the directory “Dir2;” the parent node ID of the directory “Dir2” is “1,” which means the parent directory is the directory “Dir1;” and the parent node ID of the directory “Dir1” is “0,” which means the parent directory is the directory “Dir0.” Therefore, the directory structure restoring module 203 restores the full path of the directory “Dir4-1” which is “/Dir0/Dir1/Dir2/Dir3/Dir4-1.” If the path of the other file in the same directory “Dir4-1” layer needs to be restored, the directory information reading module 202 reads the start location of the directory in the same directory “Dir4-1” layer. The start location of the directory is “60,” which means files exist in the same directory “Dir4-1,” including “File5-1,” “File5-2” and “File5-3.” The parent directory of those files is directory “Dir4-1.” Then the directory structure restoring module 203 respectively restores those files' directory. Therefore, the start location of the directory is “120” which has completely been restored.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A system for restoring a file directory structure, comprising:
a storage for storing files and a file directory table;
a computer for performing a file directory restoring program, and the file directory restoring program comprising:
a directory table constructing module for constructing the file directory table according to the tree file directory;
a directory information reading module for reading file directory information from the file directory table according to a selected file directory ID; and
a directory structure restoring module for restoring the tree file directory structure according to the file directory information.

2. The system according to claim 1, wherein the file directory table stores a start location of a file directory, a parent node of a directory node, a sub-node of the directory node, a file name, and length of the file name.

3. The system according to claim 1, wherein the directory information include node information, parent node information of the node, sub-node information of the node, and the same directory layer node information.

4. A method for restoring a file directory structure, comprising the steps of:
constructing a file directory table;
reading a file directory in the file directory table;
confirming the start location of the file directory in the file directory table;
reading a parent directory of the file directory according to the start location;
determining whether the parent directory is a root directory;
restoring a full path of the file directory structure based on the parent directory, if the parent directory is a root directory;
determining whether the file directory exists a file with the same parent node in the same directory layer; and
restoring the full path of the file directory structure based on the parent node, if the file directory exist a file with the same parent node in the same directory layer.

5. The method according to claim 4, wherein the step of constructing a file directory table further comprises the steps of:
defining a directory ID of the file directory; and
recording the file directory information in the file directory table according to the directory ID.

6. The method according to claim 5, wherein the file directory information include node information, parent node information of the node, sub-node information of the node, and the same directory layer node information.

7. The method according to claim 5, wherein file directory has an ID recorded in the file directory table, whose ID is predefined according to its sequence in the file directory table.

8. The method according to claim 4, wherein the step of determining whether the parent directory is a root directory further comprises the step of reading a top of the parent directory of the file directory until the parent directory is the root directory.

9. The method according to claim 4, wherein the step of determining whether the parent directory is a root directory is decided by checking whether the parent directory ID is equal to “0.”

10. The method according to claim 4, wherein the step of determining whether the file directory has a same parent node of the file directory in the same directory layer is performed by searching the same parent directory ID as the file directory in the file directory table.

11. A method for processing information of a file directory structure and file data therein, comprising the steps of:
assigning a recognizable shorten identification (ID) to each file directory in a file directory structure to be processed;
itemizing related information of said each file directory and files in said each file directory based on said correspondingly assigned shorten ID for said each file directory; and
processing said files after identifying said files by means of utilizing said shorten ID for said each file directory based on said itemized related information of said each file directory and said files.

12. The method according to claim 11, wherein said related information of said files comprises a full path of said files in said file directory structure.

13. The method according to claim 11, wherein a file directory table is used to itemize said related information of said each file directory and said files.
